(19) United States
(12) Patent Application Publication
(10) Pub. No.: US 2025/0226771 A1
(43) Pub. Date: Jul. 10, 2025

(54) SPONTANEOUSLY GENERATED COHERENCE IN A FOUR-LEVEL ATOMIC SYSTEM UNDER INDUCED CHIRALITY

(71) Applicant: Institute of Applied Technology, Fatima College of Health and Science, Abu Dhabi (AE)

(72) Inventors: Nadia Boutabba, Abu Dhabi (AE); Rashid Ahmad, Multan Village - Swat District (PK); Hazrat Ali, Kokarai Village - SWAT District - KPK (PK); Iftikhar Ahmad, Matta Village, Swat District (PK)

(73) Assignee: Institute of Applied Technology, Fatima College of Health and Science, Abu Dhabi (AE)

(21) Appl. No.: 18/591,763

(22) Filed: Feb. 29, 2024

(30) Foreign Application Priority Data
Jan. 9, 2024 (AE) P6000079/2024

(51) Int. Cl. H02N 99/00

(52) U.S. Cl. CPC H02N 99/00

(57) ABSTRACT

An apparatus includes two identical finite slabs. The two identical finite slabs are constructed of cesium vapor atoms. The two identical finite slabs are under an effect of electromagnetically induced chirality. The electromagnetically induced chirality effect is based on the interference between an electric and a magnetic field. A Casimir force is computed based on the effect of a spontaneously generated coherence (SGC) and the relative phase between the electromagnetic fields.

### BACKGROUND

Nanometer-sized electromechanical devices have made significant advances in recent years due to their low power consumption, high performance and quick functionality. These devices are widely used in a variety of sensors, cellular and optical communication among other pertinent applications. However, various technical issues, including stiction, adhesion and friction, provide significant barriers to developing these nanoscale electromechanical devices.

The fundamental cause of these technical problems is the Casimir force (CF) in addition to van der Waals forces. The strength of the CF increases monotonically as the distance between the two objects decreases and vice versa. The CF manifests as the radiation pressure that the quantum vacuum fluctuations exert on reflectors. The attractive CF poses a significant challenge namely in the form of stiction. However, there is no current process to control and manipulate the CF.

### BRIEF DESCRIPTION OF DRAWINGS

FIGS. 1A and 1B are schematic diagrams of example systems;

FIGS. 2A 2B, 2C, 2D, 2E, and 2F are diagrams of example graphs;

FIG. 3 is a diagram of an example graph;

FIG. 4 is a diagram of an example graph;

FIG. 5 is a diagram of an example graph;

FIG. 6 is a diagram of an example graph;

FIG. 8 is a diagram of a network environment; and

FIG. 9 is a diagram of an example computing device.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein may allow for a coherent control of the Casimir force (CF) in a four-level atomic system under electromagnetically induced chirality. In embodiments, two parallel slabs of finite length in a quantum vacuum are composed of ensembles of cesium vapor atoms in a four-level double A-type atomic configuration. By the use of the quantum interference (QI) effect which arises from the cross-coupling between the different spontaneous emission pathways, the CF may be fully controlled in the system via the spontaneously generated coherence (SGC) and the relative phase between the electromagnetic fields.

In embodiments, the chirality in the atomic system can be induced by the SGC and the probe detuning, satisfying passivity conditions. In embodiments, the QI in the system can be manipulated and controlled by changing the angle between the dipole moments, as the SGC is sensitive to their relative orientations. In embodiments, the dependence of the Casimir interaction energy on the relative phase of the control fields. In embodiments, the Casimir interaction energy can be switched from negative to positive for a specific given phase value.

Nanometer-sized electromechanical devices have made significant advances in recent years due to their low power consumption, high performance and quick functionality. These devices are widely used in a variety of sensors, cellular and optical communication among other pertinent applications. However, various technical issues, including stiction, adhesion and friction, provide significant barriers to developing these nanoscale electromechanical devices.

One reason for these potential issues is the Casimir force (CF) in addition to van der Waals forces. The Casimir effect (CE) arose as the most prominent macroscopic mechanical phenomenon of quantum vacuum fluctuations that was first theoretically predicted by Hendric Casimir. In a quantum vacuum, Casimir closely positioned two uncharged parallel reflectors and discovered an attractive force between them. The strength of this force increases monotonically as the distance between the two objects decreases and vice versa.

This force manifests as the radiation pressure that the quantum vacuum fluctuations exert on reflectors. In fact, reflectors create a cavity where, depending on the cavity resonance, quantum vacuum fluctuations can be enhanced or suppressed. For instance, at resonance, vacuum fluctuations inside the cavity are enhanced, whereas reflectors are pushed apart and the other way around. As a result, CF appears to be both repulsive and attractive. Nonetheless, the attractive CF poses a significant challenge namely in the form of stiction, which may prohibit these systems from operating as intended for a particular amount of time.

Unlike the attractive force, the repulsive one provides an anti-stiction effect which was studied in the case of micro and nano electromechanical systems. The Casimir force in a binary liquid mixture under critical temperature is demonstrated experimentally and can control nano and microscopic objects with high precision. To measure the Casimir interaction between two spheres, the topographical alignment method was carried out in. Using Weyl semi-metals and a chiral medium, the CF was calculated from the system's optical response. In hyperbolic metamaterials, the CF repulsive behavior arises from the difference between the two optical axes of the metamaterials.

Systems, methods, and/or devices described herein resolves the challenges associated with manipulating and controlling the CF. Furthermore, systems, methods, and/or devices described herein to measure the CF in micro and nano electro-mechanical systems such as NEMS and MEMS, respectively, and also to change the CF from being attractive to repulsive.

In embodiments, chiral materials while structuring nanometer-sized devices is a key route to achieve this shift (attractive-repulsive). Thus, CF is computed using the Lifshtiz theory, and the anti-stiction effect caused by the repulsive CF is demonstrated to be largely due to chirality. In embodiments, the concept of oscillating particles was explored experimentally to show how the analogue dynamical Casimir effect could be realized in the near-infrared optical regime in a dispersion-oscillating photonic crystal fiber.

From another side, recent progresses in the field of quantum optics is directed towards the use of quantum interference (QI) and quantum coherence in order to control and manipulate atomic systems. One pertinent example of the interference effect is the electromagnetically induced transparency (EIT) widely studied in multilevel atomic systems theoretically and experimentally. Hence, it was shown that the EIT enhances the atomic population inversion, suppresses absorption, induces the giant Kerr effect etc. Besides the EIT, The QI of spontaneous emission channels is described by another kind of coherence, called spontaneously generated coherence (SGC), also referred to as vacuum-induced coherence (VIC).

In embodiments, SGC can be created by the QI of spontaneous emissions from a single excited state to two nearby lower states or from two nearby upper atomic states to a shared lower atomic level, such as in the case of the A or V-type atomic system, respectively. Many researchers in the fields of quantum optics, nonlinear optics, quantum control, and photonics were interested in the spontaneously generated coherence. Indeed, pertinent methods are investigated to obtain and control the SGC such as considering atoms in a multi-layer dielectric plate cavity driven by a microwave field, and two additional laser fields.

The effect of the SGC on the absorption spectrum of a multi-level atom (like the rubidium), is explored both theoretically and experimentally. Typically, the influence of the SGC on the optical properties of the V-type atomic system was presented in. Most recently, the optical limiting and saturable absorption are studied in a V-type atomic medium, where it is demonstrated that by including the SGC effect in the system, the saturable absorption is reversed. Along with other effects, the effect of SGC enables the enhancement of nonlinear Kerr absorption in multi-level atomic systems. Finally, the coherent population transfer in a double A-type system via SGC is demonstrated.

Experimentally, the SGC has been investigated by modifying the property of the vacuum with extra driving fields, such as the laser field, the microwave field and the DC field. Furthermore, it is worth mentioning the study of Dong et al in where the authors investigated incoherent pump field, SGC, and relative phase effect on the optical propagation dynamics of a multilevel atomic configuration. They found that while pulse modulation increase with the SGC, it can be decreased by selecting an appropriate incoherent rate and relative phase. Although the SGC effect, as well as the relative phase of applied fields and the coherent driving fields, were extensively studied, there is no such study on the CF under electromagnetically induced chirality.

In contrast, the systems, methods, and/or devices described herein, the SGC effect on the physics of Casimir interactions between two identical chiral atomic media are investigated. In embodiments, the quantum interference effect are used to coherently control the CF between two parallel identical chiral slabs. In embodiments, a four-level double A-type atomic system is considered and it is shown that by changing the value of SGC, CF can switch from attractive to repulsive and vice versa. Moreover, the systems, methods, and/or devices described herein, the applied fields form a close interaction loop.

In such a closed-loop system, the relative phase of the control fields has an appreciable effect on the CF. In embodiments, the CF can switch between attractive and repulsive via the relative phase of the control fields. In embodiments, the passivity conditions are analyzed in connection with the Casimir-Lifshitz (C-L) formula and observe that they are satisfied. Therefore, using SGC with the electromagnetically induced chirality in atomic systems might open the way for efficient control and manipulation of the Casimir attraction and repulsion.

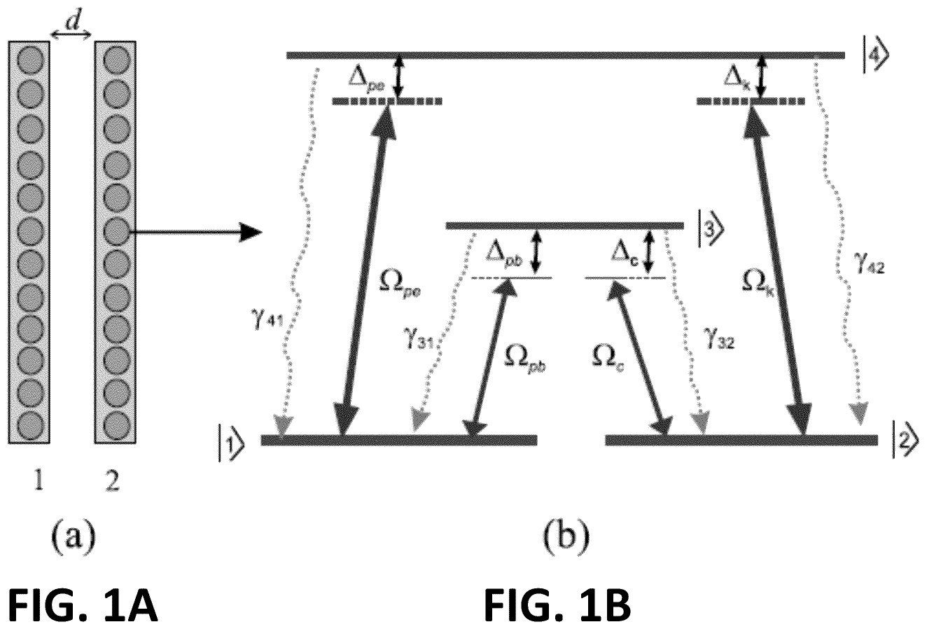

FIGS. 1A and 1B are schematic diagrams of the proposed model that is described in the systems, methods, and/or devices described herein. As shown in FIG. 1A, two closely spaced identical parallel slabs are provided in a quantum vacuum and separated by a distance d (within the quantum vacuum). In embodiments, the inter-slabs distance d is of the order of microns. As shown in FIG. 1B, the slabs are composed of ensembles of cesium vapor atoms where each atom follows a four-level double A-type atomic configuration. In embodiments, the system consists of two doubly-degenerate ground states|1 [symbol] =|[6S_{1/2}, F=3] [symbol] and |2 [symbol] =|[6S_{1/2}, F=4] [symbol] and two excited states|3 [symbol] =|[6P_{3/2}, F=2] [symbol] and |4 [symbol] =|[6F_{3/2}, F=4] [symbol] .

In embodiments, a weak probe electric field having Rabi frequency Ωₚₑ initiates transition between |1 [symbol] ⇔|4 [symbol] , whereas, a weak magnetic probe field with Rabi frequency Ω_{pb} causes transition |1 [symbol] ⇔|3>. Also, the two excited energy levels |3> and |4 [symbol] are coupled with the same lower state |2> via strong and control fields having Rabi frequencies Ω_{c} and Ωₖ, respectively. |1 [symbol] and |2> are nearly generated states since the two transitions related to the excited state interact with the same vacuum mode. In embodiments, the complex Rabi frequencies Ωpe and Ω_{pb} which are related to the electric (E) and magnetic (B) fields, respectively, are given by equation (1) as:

$${Ω}_{pe} = \frac{( {\vec{d}}_{41} \cdot {\hat{ϵ}}_{pe} )}{ℏ} \cdot E , \qquad {Ω}_{pb} = \frac{( {\vec{μ}}_{31} \cdot {\hat{ϵ}}_{pb} )}{ℏ} \cdot B ,$$

where \vec{d}₄₁ and \vec{μ}₃₁ are the electric and magnetic dipole moments, respectively.

The Hamiltonian (interaction) of the model in the electric dipole approximation can be obtained as equation (2) as:

$${H}_{I} = - ℏ [ {Ω}_{pe} {e}^{- i {Δ}_{pe} t} \vert 4 〉 〈 1 \vert + {Ω}_{pb} {e}^{- i {Δ}_{pb} t} \vert 3 〉 〈 1 \vert + {Ω}_{c} {e}^{- i {Δ}_{c} t} \vert 3 〉 〈 2 \vert + {Ω}_{k} {e}^{- i {Δ}_{k} t} \vert 4 〉 〈 2 \vert + c . c ] .$$

Here, Δₚₑ=ω₄₁-ωₚₑ, Δ_{pb}=ω₃₁-ω_{pb}, Δ_{c}=ω32−ω_{c} and Δₖ=ω₄₂−ωₖ are the detunings between the electron transitions frequencies and the corresponding applied fields frequencies. Moverover, Ωₚₑ=|Ωₚₑ|e^{-iϕ}, where ϕ is the relative Phase.

In embodiments, the density matrix equations for the four-level atom are written as equation (3) as:

$$ρ = {\sum }_{k , l} {ρ}_{kl} {e}^{i ( {ω}_{k} - {ω}_{l} ) t} 〈 k \vert l 〉$$

where k, l denote the levels 1, . . . 4 and ω_{k,l} are the corresponding frequencies. In terms of the basis set of the bare atom {|1 [symbol] , |2 [symbol] , |3>, |4 [symbol] } there is equation (4):

$${Φ}_{k}^{+} {Φ}_{l} = \vert k 〉 〈 l \vert and ρ = {\sum }_{k , l = 0}^{4} \vert k 〉 {ρ}_{kl} 〈 l \vert ,$$

P where Φ^{†}(Φ) is the raising (lowering) operator for the corresponding spontaneous decay. Hence, the density matrix evolution is equation (5):

$$\dot{ρ} = \frac{i}{h} [ H , ρ ] - \frac{1}{2} \sum {γ}_{ij} ( {Φ}^{†} Φρ + {ρΦ}^{†} Φ - 2 {ΦρΦ}^{†} )$$

In embodiments, the temporal dynamics of the diagonal and the off-diagonal elements are given in the appendix. For the density matrix, the term p\sqrt{γ₃₁γ₃₂} expresses QI arising from the cross-coupling between the two spontaneous emission paths, i.e., |3 [symbol] →|1 [symbol] and |3¢ →|2 [symbol] . The strength of QI depends on the dimensionless parameter p, which shows the alignment of the two dipole moments, i.e., \vec{μ}₃₁, and \vec{μ}₃₂, and can be defined as equation (6) as:

$$p = \vec{{μ}_{31}} \cdot \vec{{μ}_{32}} / \vert \vec{{μ}_{31}} \cdot \vec{{μ}_{32}} \vert = cos θ$$

with θ is the angle between \vec{μ}₃₁ and \vec{μ}₃₂. In embodiments, the SGC effect is very sensitive to the orientations of the two dipole moments. For θ=0° between \vec{μ}₃₁, and \vec{μ}₃₂, p=1 and QI between the two decay paths is maximum, whereas, for θ=90°, p=0 and QI due to spontaneous emission vanishes. Thus QI can be produced by adjusting the angle θ between \vec{μ}₃₁ and \vec{μ}₃₂. The strong field Ω_{c} and magnetic probe field Ω_{pb} connected to the angle θ can be written as equation (7) as:

$${Ω}_{c} = {Ω}_{c}^{0} sin θ = {Ω}_{c}^{0} \sqrt{1 - {p}^{2}}$$

In embodiments, the density matrix elements \tilde{ρ}₄₁ and \tilde{ρ}₃₁ are evaluated at the steady state. Hence, Ωₚₑ and Ω_{pb} are considered at the first order, while Ω_{c} and Ωₖ are assumed in all order of perturbations, and obtained them in terms of E and B which are related to H and M. All the calculations are given in the appendix. In embodiments, the electric and magnetic response of the atomic medium to the probe field are linked with the coherent terms \tilde{ρ}₄₁ and \tilde{ρ}₃₁, respectively via the relations: P=N \vec{d}₄₁ \tilde{ρ}₄₁ and M=N \vec{μ}₃₁ \tilde{ρ}₃₁, where N stands for the atomic number density and \vec{d}₄₁ (\vec{μ}₃₁) is the probe field transition electric (magnetic) dipole moment. Putting equation (35) in P, rho-t-3 in M, and making use of B=μ₀ (H+M), one can obtain the polarization and magnetization of the system P and M.

In embodiments, that chirality can be induced by the simultaneous application of magnetic probe and electric probe in the model that leads to magnetic and electric dipole transitions. Chirality has critical importance in controlling both repulsive and attractive Casimir forces. A chiral atomic medium is characterized by the following equation (8):

$$( \begin{matrix}P \\ M\end{matrix} ) = ( \begin{matrix}{ϵ}_{0} {χ}_{e} & \frac{{β}_{EH}}{c} \\ \frac{{β}_{HE}}{c {μ}_{0}} & {χ}_{m}\end{matrix} ) ( \begin{matrix}E \\ H\end{matrix} ) ,$$

where λₑ (λₘ) is the electric (magnetic) susceptibility, while β_{EH} and β_{HE} are the complex chirality coefficients, respectively. Comparing equations (41) and (41) with equation (8), the electric permittivity (ϵ=1+λₑ), magnetic permeability (μ=1+λₘ), and the complex chiral coefficients are obtained (with equations (9), (10), (11), and (12)):

$$ϵ = 1 + \frac{{Nd}_{41} {Γ}_{EE}}{{ϵ}_{0}} + \frac{{N}^{2} {μ}_{0} {d}_{41} {μ}_{31} {Γ}_{EB} {Γ}_{BE}}{{ϵ}_{0} ( 1 - N {μ}_{0} {μ}_{31} {Γ}_{BB} )} ,$$

$$μ = 1 + \frac{N {μ}_{0} {μ}_{31} {Γ}_{BB}}{1 - N {μ}_{0} {μ}_{31} {Γ}_{BB}} ,$$

$${β}_{EH} = \frac{Nc {μ}_{0} {d}_{41} {Γ}_{EB}}{1 - N {μ}_{0} {μ}_{31} {Γ}_{BB}} ,$$

$${β}_{HE} = \frac{Nc {μ}_{0} {μ}_{31} {Γ}_{BE}}{1 - N {μ}_{0} {μ}_{31} {Γ}_{BB}} .$$

In order to introduce the electric and magnetic local-field effects, E and B are replaced in equations (35) and (36) by local-fields, i.e., as equation (13):

$${E}_{L} = E + \frac{P}{3 {ϵ}_{0}} , {B}_{L} = {μ}_{0} ( H + \frac{M}{3} ) ,$$

As such, the electric permittivity, magnetic permeability and the complex chirality coefficients are modified into the form:

$$ϵ = 1 + \frac{{Nd}_{41} {Γ}_{EE} + \frac{1}{3} {N}^{2} {μ}_{0} {d}_{41} {μ}_{31} ( {Γ}_{EB} {Γ}_{BE} - {Γ}_{EE} {Γ}_{BB} )}{{ϵ}_{0} κ} , \qquad equation ( 14 )$$

$$μ = 1 + \frac{N {μ}_{0} {μ}_{31} {Γ}_{BB} + \frac{1}{3} {N}^{2} {μ}_{0} {d}_{41} {μ}_{31} ( {Γ}_{EB} {Γ}_{BE} - {Γ}_{EE} {Γ}_{BB} )}{κ} , \qquad equation ( 15 )$$

$${β}_{EH} = \frac{Nc {μ}_{0} {d}_{41} {Γ}_{EB}}{κ} , \qquad equation ( 16 )$$

$${β}_{HE} = \frac{Nc {μ}_{0} {μ}_{31} {Γ}_{EB}}{κ} , \qquad equation ( 17 )$$

where, equation (18) is:

$$κ = 1 - \frac{N}{3 {ε}_{0}} ( {ε}_{0} {μ}_{0} {μ}_{31} {Γ}_{E B} + {d}_{41} {Γ}_{E E} ) - \frac{{N}^{2} {μ}_{0} {d}_{41} {μ}_{31}}{9 {ε}_{0}}$$

To determine the results for the Casimir interaction energy per unit area (CIEPA) E (d)/A and Casimir force per unit area (CFPA) F (d)/A, passivity conditions are described herein that are necessary for the analyticity of the integrand of equations (43) and (44) in the upper half of the complex plane i.e., Re [ξ]>0. In embodiments, passivity assures the stability of the intracavity field and is closely connected to the energy consideration. Specifically, passivity conditions are satisfied with the set of inequalities, i.e., Im[ϵ]>0, Im[μ]>0 and V̅>0, respectively. Here, Im[ϵ] (Im[μ]) is the imaginary part of permittivity (permeability) and V̅ is the determinant of the matrix which can be defined as:

$$∇ = \frac{1}{{c}^{2}} [ Im [ ϵ ] Im [ μ ] - {( Im [ β ] )}^{2} ] ,$$

where β is the chirality coefficient.

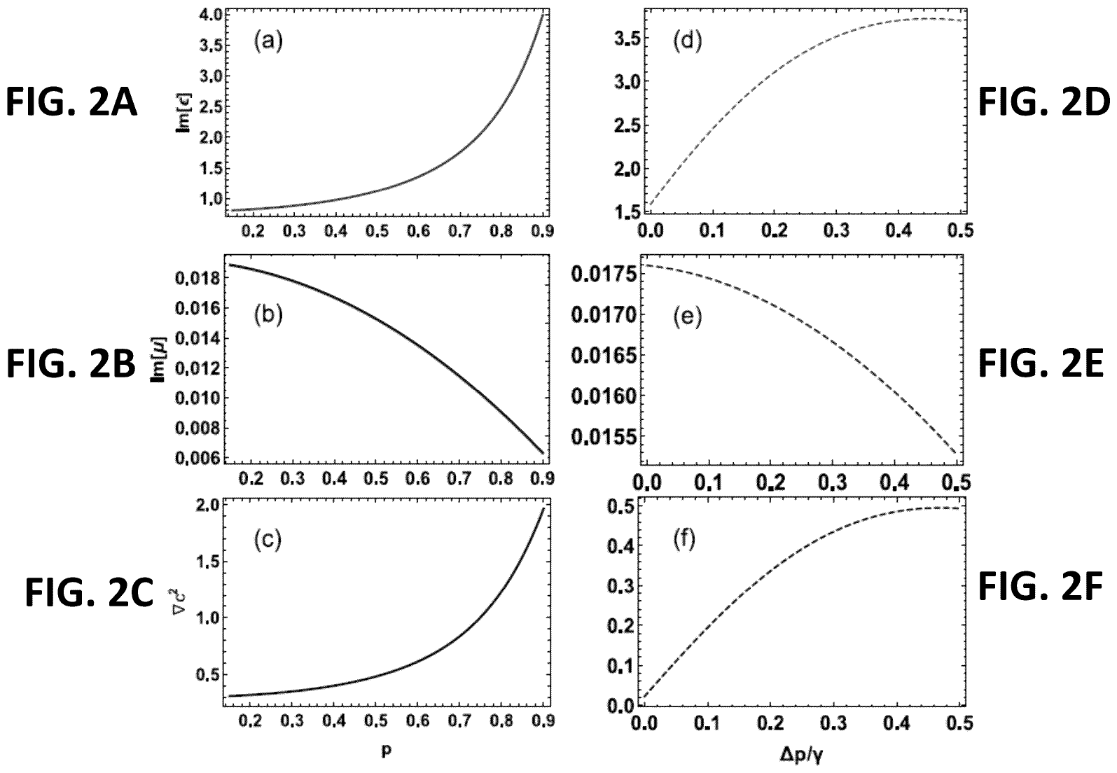

Hence, these inequalities can be satisfied by the proposed chiral medium in a double A-type atomic system described herein. In FIGS. 2A, 2B, and 2C, Im[ϵ], Im[μ] and V̅c² are plotted as a function of the strength of SGC parameter p. This is due to the fact that p can be used as a controlling parameter for the CF. In FIGS. 2D, 2E, and 2F, Im[ϵ], Im[μ] and V̅c² are plotted as a function of the probe field detuning Δₚ/γ. In embodiments, these plots clearly show that Im[ϵ], Im[μ] and V̅c² as a function of p and Δₚ/γ, respectively, are always positive and, hence in agreement with the conditions of passivity. For numerical results, the Rabi frequencies, spontaneous emission rates and the probe field detunings are taken as Ω_{c}⁰=2.5γ, Ωₖ=1γ, γ₃₁=γ₄₁=1γ and γ₂₁=0.01γ, Δₚ=0.5γ, Δ_{c}=0γ, where γ is the scaling parameter and equals to 1 MHz. In embodiments, the transition electric (magnetic) dipole matrix element can be defined as: d₄₁ (μ₃₁)=\sqrt{3ℏγ₄₁ (γ₃₁)λ³/8π²}, where λ=852.3 nm and the atomic number density is N=1×10¹² m⁻³. Under these considerations, all the passivity conditions are fulfilled here, as shown in FIGS. 2A to 2F.

In embodiments, Plots of FIGS. 2A and 2D, Im[6], FIGS. 2B and 2E, Im[μ], and in FIGS. 2C and 2F V̅c²=[Im[ϵ] Im[μ]−(Im[β])²] against p and Δₚ/γ, respectively. In embodiments, the fixed parameters are Ω_{c}⁰=2.5γ, Ωₖ=1γ, γ₃₁=γ₄₁=1γ, γ₂₁₌0.01γ, Δ_{c}=0γ, N=1×10¹² m⁻³, whereas, Δₚ=0.5γ for FIGS. 2A-2D and p=0.3 for FIGS. 2D-2F.

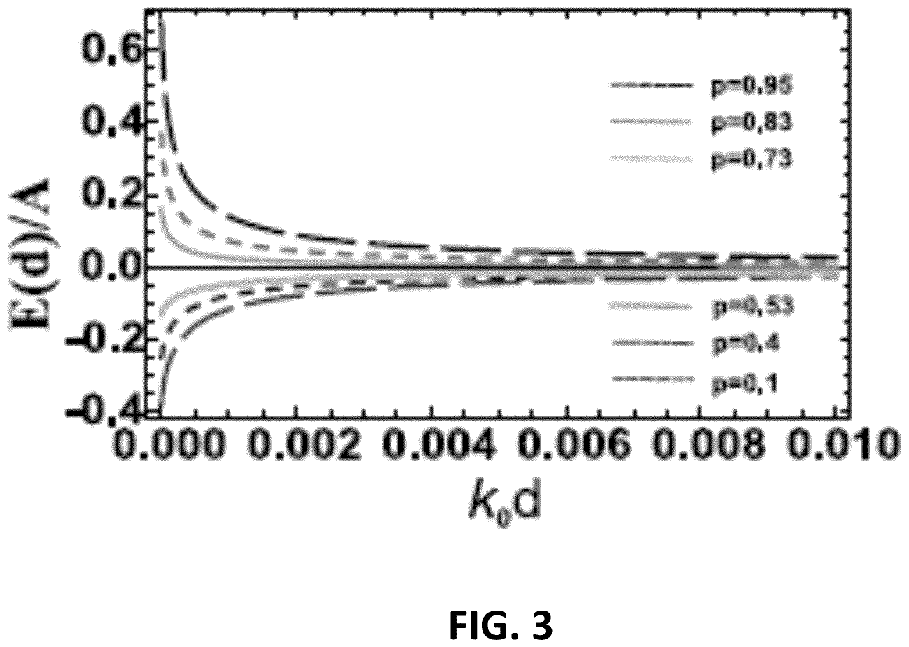

FIG. 3 is an example graph that depicts the plot between CIEPA E (d)/A (in units of hck₀³) versus k₀d for various choices of the parameter p. k₀=10⁻² μm⁻¹ while d is the inter-slabs distance. In embodiments, the values of p are: (i) 0.1, (ii) 0.4, (iii) 0.53, (iv) 0.73, (v) 0.83 and (vi) 0.95, respectively. Based on FIG. 3, CIEPA is negative for p=0.1, p=0.4 and p=0.53 and it stays negative for all the values of k₀d. However, its magnitude decreases as the inter-slabs distance increases and becomes negligibly small for k₀d>0.004. Moreover, it can be seen from FIG. 3 that as the strength of SGC is increased, i.e., p=0.73, p=0.83 and p=0.93, the CIEPA becomes positive and remains positive for all the values of k₀d. But in the same manner, its magnitude decreases with the increasing distance between the two chiral slabs and almost vanishes for k₀d>0.004. Thus, the repulsive behavior of the Casimir force is observed for the weak SG coherence and attractive behavior for the strong SG coherence in the system.

E(d)/A

E (d)/A [0038] As described previously. the Casimir force was achieved as positive for low control field values and negative for high control field values. In this particular example, 12 times enhanced Casimir force than the one predicted in. These results clearly confirm that CIEPA is strongly influenced by the strength of SGC (p) and control over p can provide sufficient new freedom to switch CIEPA from negative to positive values and vice versa.

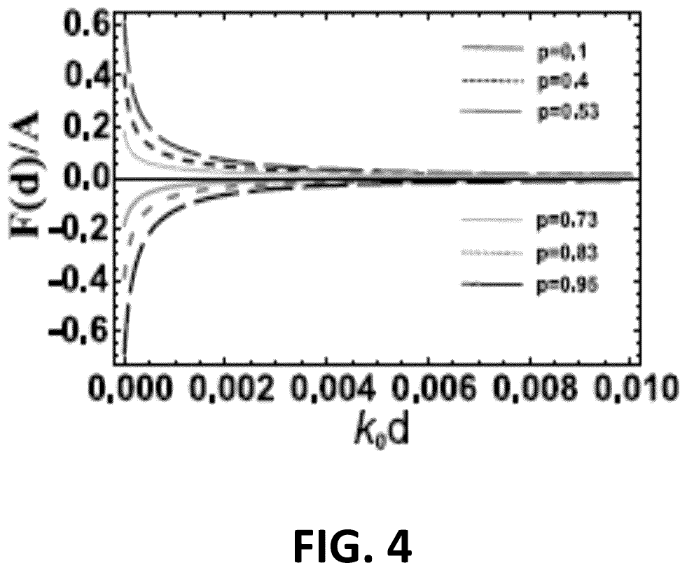

In order to understand the behavior of CF, derivative of the CIEPA E (d)/A is taken to obtain the sign of the CFPA F (d)/A. In embodiments, the negative and positive sign leads to repulsive and attractive CF, respectfully. FIG. 4 describes a graph with CFPA F (d)/A in units of K (pressure) is plotted against k₀d for different values of the strength of SGC (similar to FIG. 3). In FIG. 4, K˜ 10-3 Nm⁻². As CFPA is the negative gradient of E (d)/A, therefore, CFPA is positive for the negative values of CIEPA (p=0.1, p=0.4, p=0.53) and negative for the positive values of CIEPA (p=0.73, p=0.83, p=0.95). FIG. 4 describes that the variation of p can result in attractive or repulsive CFPA. From these observations, one can clearly see the effect of SGC on the CIEPA, as well as on the CFPA.

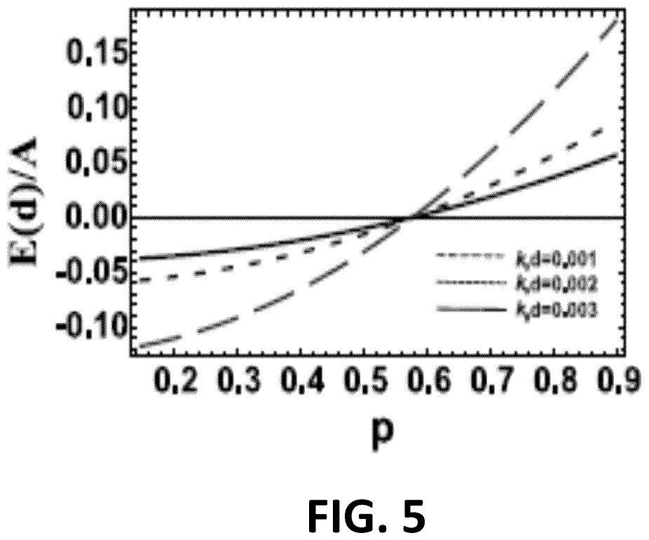

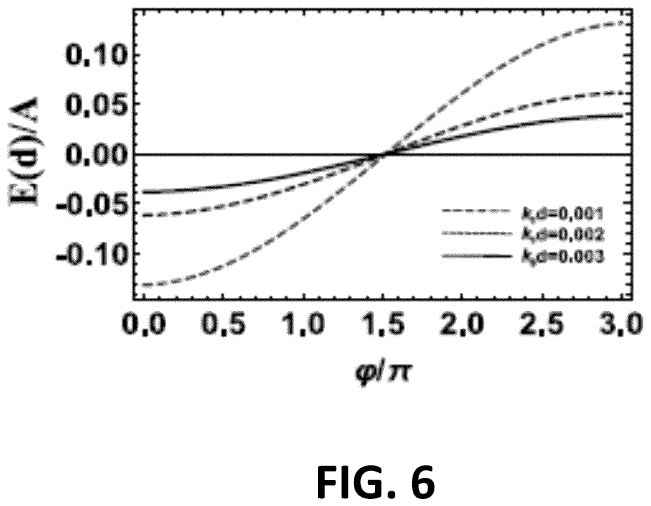

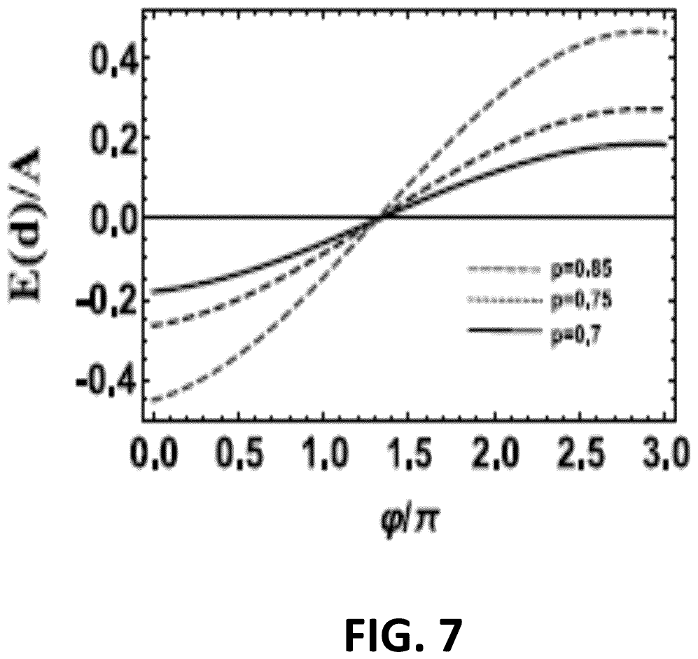

FIG. 5 is an example graph where CIEPA is plotted as a function of p for different values of the inter-slabs spacing k₀d, i.e., (i) 0.001, (ii) 0.002 and (iii) 0.003. The reason for taking these values of k₀d is because the magnitude of CIEPA is relatively high for k₀d<0.004 (see, for example FIG. 3). In embodiments, the value of p increases from 0.1 to 0.58, the CIEPA remains negative. Beyond this point, CIEPA becomes positive. The crossover from negative to positive occurs at p˜ 0.59. It is clear from here, that response of the CIEPA to the strength of SGC depends on the values k₀d between the two chiral slabs. Furthermore, the crossover of CIEPA from negative to positive for each different value of k₀d takes place at a certain value of p. Thus, by controlling the strength of SGC, CIEPA can be switched from negative to positive and vice versa. Accordingly, the results from FIG. 5 are in complete agreement with that of FIG. 5. Thus, FIG. 5 is an example graph that is a plot of CIEPA E (d)/A versus p for (i) k₀d=0.001, (ii) k₀d=0.002 and (iii) k₀d=0.003. FIG. 6 is an example graph that is a plot of CIEPA (E (d)/A) versus q/Tt for (i) k₀d=0.001, (ii) k₀d=0.002 and (iii) k₀d=0.003 and p=0.59. FIG. 7 is an example plot of CIEPA (E (d)/A) versus /π for (i) p=0.7, (ii) p=0.75 and p=0.85 and k₀d=0.003.

In embodiments, the relative phase of the control fields on the CIEPA are analyzed for two cases. In the first case, CIEPA is plotted (in units of hck₀³) against the relative phase o/n for different values of k₀d, i.e., (i) 0.001, (ii) 0.002 and (iii) 0.003 and fix the value of SGC parameter p as p=0.59, as shown in FIG. 6. In embodiments, CIEPA, which is initially negative, increases as the relative phase increases and becomes positive for a certain value of the relative phase of the control fields. Thus, the crossover takes place at φ≈1.5π, which agrees with FIG. 5.

In the second case: CIEPA is plotted as a function of the relative phase o/n for different choices of the SGC parameter p, i.e., (i) p=0.7, (ii) p=0.75 and (iii) p=0.85 and fix the value of the inter-slabs spacing as k₀d=0.003, as shown in FIG. 7 As shown, CIEPA switches from negative to positive at a certain value of the relative phase but is different from the previous case. In this case, the crossover from negative to positive occurs at φ≈1.3π. It can be seen from these plots that CIEPA is strongly influenced by the relative phase of the control fields, and depending on the choice of the relative phase o/T, one can switch CIEPA from negative (attractive) to positive (repulsive) and the other way around.

Accordingly, two identical finite slabs are considered in a quantum vacuum made of Cesium vapor atoms under the effect of electromagnetically induced chirality. In embodiments, this effect arose due to the interference between an electric and a magnetic field known as the cross-coupling. Accordingly, the atomic media are analyzed in terms of the classical density matrix formalism. In embodiments, the Casimir force is computed while considering the effect of the spontaneously generated coherence (SGC) and the relative phase between the electromagnetic fields. Additionally, the Casimir interaction energy per unit area (CIEPA) and force (CFPA) are determined using the Casimir-Lifshitz formula. Thus, CIEPA and CFPA can be controlled and manipulated via the SGC. Furthermore, the CFPA can be significantly varied and switched from attractive (positive) to repulsive (negative) and vice versa via the variation of the strength of SGC. By doing so, the systems, methods, and/or devices described herein can be used nanometer-sized devices provides for a new technique to manipulate the shift attractive-repulsive of the Casimir force.

The density matrix of the four-Level atomic system is given by equations (19) to (34):

$${\dot{ρ}}_{41} = ( - i {Δ}_{pe} - {γ}_{41} ) {ρ}_{41} + i {Ω}_{pe} ( {ρ}_{11} - {ρ}_{44} ) + i {Ω}_{k} {ρ}_{21} - i {Ω}_{pb} {ρ}_{43} - i {Ω}_{pe} {ρ}_{44} \text{?}$$

$${\dot{ρ}}_{21} = [ ( i {Δ}_{pe} - i {Δ}_{c} ) - {γ}_{21} ] {ρ}_{21} + i {Ω}_{c} {ρ}_{31} + i {Ω}_{k} {ρ}_{41} - i {Ω}_{pb} {ρ}_{23} - i {Ω}_{pe} {ρ}_{24} + 2 p \sqrt{{γ}_{31} {γ}_{32}} {ρ}_{33} \text{?}$$

$${\dot{ρ}}_{31} = ( - i {Δ}_{pb} - {γ}_{31} ) {ρ}_{31} + i {Ω}_{pb} ( {ρ}_{11} - {ρ}_{33} ) + i {Ω}_{c} {ρ}_{21} - i {Ω}_{pe} {ρ}_{43} \text{?}$$

$${\dot{ρ}}_{11} = - {γ}_{11} {ρ}_{11} + i {Ω}_{pb} {ρ}_{31} + i {Ω}_{pb} {ρ}_{41} - i {Ω}_{pb} {ρ}_{13} - i {Ω}_{pe} {ρ}_{14} \text{?}$$

$${\dot{ρ}}_{14} = ( - i {Δ}_{pe} - {γ}_{14} ) {ρ}_{14} + i {Ω}_{pb} {ρ}_{43} - i {Ω}_{pe} {ρ}_{44} - i {Ω}_{pe} {ρ}_{11} - i {Ω}_{K} {ρ}_{12} \text{?}$$

$${\dot{ρ}}_{12} = ( - i {Δ}_{c} + i {Δ}_{pe} - {γ}_{21} ) {ρ}_{12} + i {Ω}_{pb} {ρ}_{32} + i {Ω}_{pe} {ρ}_{42} - i {Ω}_{c} {ρ}_{13} + 2 p \sqrt{{γ}_{31} {γ}_{32}} {ρ}_{33} - i {Ω}_{k} {ρ}_{14} \text{?}$$

$${\dot{ρ}}_{13} = ( - i {Δ}_{pb} - {γ}_{13} ) {ρ}_{13} + i {Ω}_{pb} {ρ}_{33} + i {Ω}_{pe} {ρ}_{43} + i {Ω}_{pb} {ρ}_{11} - i {Ω}_{c} {ρ}_{12} \text{?}$$

$${\dot{ρ}}_{22} = - {γ}_{22} {ρ}_{22} + i {Ω}_{c} {ρ}_{32} + i {Ω}_{k} {ρ}_{42} - i {Ω}_{c} {ρ}_{23} - i {Ω}_{k} {ρ}_{24} \text{?}$$

$${\dot{ρ}}_{23} = ( - i {Δ}_{c} - {γ}_{23} ) {ρ}_{23} + i {Ω}_{c} {ρ}_{33} + i {Ω}_{k} {ρ}_{43} - i {Ω}_{pb} {ρ}_{21} - i {Ω}_{c} {ρ}_{22} \text{?}$$

$${\dot{ρ}}_{24} = ( - i \text{?} - {γ}_{24} ) {ρ}_{24} + i \text{?} {ρ}_{34} + i {Ω}_{k} ( {ρ}_{44} - {ρ}_{22} ) - i \text{?} {ρ}_{21} \text{?}$$

$${\dot{ρ}}_{32} = ( - i {Δ}_{c} - {γ}_{32} ) {ρ}_{32} + i {Ω}_{pb} {ρ}_{12} + i {Ω}_{c} {ρ}_{22} - i {Ω}_{c} {ρ}_{33} - i {Ω}_{k} {ρ}_{34} \text{?}$$

$${\dot{ρ}}_{33} = - {γ}_{33} {ρ}_{33} + i {Ω}_{pb} {ρ}_{13} + i {Ω}_{c} {ρ}_{23} - i {Ω}_{pb} {ρ}_{31} - i \text{?} {ρ}_{32} \text{?}$$

$${\dot{ρ}}_{34} = - {γ}_{34} {\dot{ρ}}_{34} + i {Ω}_{pb} {\dot{ρ}}_{14} + i \text{?} {\dot{ρ}}_{24} - i {Ω}_{pe} {\dot{ρ}}_{31} - i {Ω}_{k} {\dot{ρ}}_{32} \text{?}$$

$${\dot{ρ}}_{42} = ( - i \text{?} - {γ}_{42} ) {ρ}_{42} + i {Ω}_{pe} {ρ}_{12} + i {Ω}_{k} {ρ}_{22} - i \text{?} {ρ}_{43} - i {Ω}_{k} {ρ}_{44} \text{?}$$

$${\dot{ρ}}_{43} = - {γ}_{43} {ρ}_{43} + i {Ω}_{pe} {ρ}_{13} + i {Ω}_{k} {ρ}_{23} - i {Ω}_{pb} {ρ}_{41} - i \text{?} {ρ}_{42} \text{?}$$

$$\text{?} = - {γ}_{44} {ρ}_{44} + i {Ω}_{pe} {ρ}_{14} + i {Ω}_{k} {ρ}_{24} - i {Ω}_{pe} {ρ}_{41} - i {Ω}_{l} {ρ}_{42} \text{?}$$

$$\text{?} \text{indicates text missing or illegible when filed}$$

In embodiments, the density matrix elements \tilde{ρ}₄₁ and \tilde{ρ}₃₁ are evaluated at the steady state. Thus, Ωₚₑ and Ω_{pb} are considered at the first order, while Ω_{c}, and Ωₖ are assumed in all order of perturbations, obtain them in terms of E and B which are related to H and M (as shown as equations (35) and (36)):

$${\tilde{ρ}}_{41} = {Γ}_{EE} E + {Γ}_{EB} B \text{?}$$

$${\tilde{ρ}}_{31} = {Γ}_{BE} E + {Γ}_{BB} B \text{?}$$

$$\text{?} \text{indicates text missing or illegible when filed}$$

where the coefficients Γ_{EE} (Γ_{BB}) and Γ_{EB}, Γ_{BE} represent electric (magnetic) and the cross-coupling polarizabilities, respectively, and can be expressed as equations (37) to (42) as:

$${Γ}_{EE} = \frac{{d}_{41} ( {α}_{2} {α}_{3} + {Ω}_{k}^{2} ) \text{?}}{ℏ ( {α}_{1} {α}_{2} {α}_{3} + {α}_{3} {Ω}_{c}^{2} + {α}_{1} {Ω}_{k}^{2} )} ,$$

$${Γ}_{BB} = \frac{\text{?} ( {α}_{1} {α}_{2} + {Ω}_{c}^{2} ) {e}^{- i φ}}{ℏ ( {α}_{1} {α}_{2} {α}_{3} + \text{?} {Ω}_{c}^{2} + {α}_{1} {Ω}_{k}^{2} )} ,$$

$${Γ}_{BE} = \frac{{d}_{41} \text{?} {Ω}_{k} {e}^{- i φ}}{ℏ ( {α}_{1} {α}_{2} {α}_{3} + {α}_{3} {Ω}_{c}^{2} + {α}_{1} {Ω}_{k}^{2} )} ,$$

$$where {α}_{1} = \text{?} {Δ}_{p} - {γ}_{31} , {α}_{2} = i ( {Δ}_{p} - {Δ}_{c} ) - {γ}_{21} and {α}_{3} = i {Δ}_{p} - {γ}_{41} \text{?}$$

$$P = ( {Nd}_{41} {Γ}_{EE} + \frac{{N}^{2} {μ}_{0} {d}_{41} {μ}_{31} {Γ}_{EB} {Γ}_{BE}}{1 - N {μ}_{0} {μ}_{31} {Γ}_{BB}} ) E + ( \frac{N {μ}_{0} {d}_{41} {Γ}_{EB}}{1 - N {μ}_{0} {μ}_{31} {Γ}_{BB}} ) \text{?}$$

$$M = ( \frac{N {μ}_{0} {d}_{31} {Γ}_{BB}}{1 - N {μ}_{0} {μ}_{31} {Γ}_{BB}} ) H + \frac{N {μ}_{31} {Γ}_{EB} E}{1 - N {μ}_{0} {μ}_{31} {Γ}_{BB}} .$$

$$\text{?} \text{indicates text missing or illegible when filed}$$

where α₁=iΔₚ-γ₃₁, α₂=i (Δₚ-Δ_{c})-γ₂₁ and α₃=iΔₚ-γ₄₁.

Based on the scattering approach, the general expression of the Casimir interaction energy per unit area (CIEPA) for the identical slabs, that are at small distance d apart in free space can be obtained as equation (43):

$$\frac{E ( d )}{A} = \frac{ℏ}{2 π} {\int }_{0}^{∞} d ξ \int \frac{{d}^{2} {k}_{‖}}{{( 2 π )}^{2}} ln det X .$$

Differentiating equation (43) results in an expression (equation (44)) for the Casimir force per unit area (CFPA):

$$\frac{F ( d )}{A} = 2 ℏ {\int }_{0}^{∞} \frac{d ξ}{2 π} \int \frac{{d}^{2} {k}_{‖}}{{( 2 π )}^{2}} KTr [ {X}^{- 1} ( 1 - X ) ] ,$$

where X=1-R¹·R²e^{-2Kd} and

$$K = \sqrt{{k}_{‖}^{2} + \frac{{ξ}^{2}}{{c}^{2}}} ,$$

whereas, R^{j} [j=1,2] being the reflection matrices and is written as equation (45):

$${R}^{j} = ( \begin{matrix}{r}_{j}^{ss} ( i ξ , {k}_{‖} ) & {r}_{j}^{sp} ( i ξ , {k}_{‖} ) \\ {r}_{j}^{ps} ( i ξ , {k}_{‖} ) & {r}_{j}^{pp} ( i ξ , {k}_{‖} )\end{matrix} ) ,$$

here, k_{∥}^{j} is the transverse wave vector, while rⱼ^{ss}, rⱼ^{sp}, rⱼ^{ps} and rⱼ^{pp} are the reflected coefficients and their explicit expressions are given as equations (46) to (49) as:

$$\text{?} = \frac{- ( {ϒ}_{+} + {ϒ}_{-} ) ( {b}_{-} {η}_{0}^{2} - {b}_{+} ) - i {η}_{0} ( {ϒ}_{+} {ϒ}_{-} - 1 ) ( {b}_{-} {b}_{+} - 1 )}{( {ϒ}_{+} + {ϒ}_{-} ) ( {b}_{-} {η}_{0}^{2} + {b}_{+} ) + i {η}_{0} ( {ϒ}_{+} {ϒ}_{-} + 1 ) ( {b}_{-} {b}_{+} - 1 )} \text{?}$$

$$\text{?} = \frac{( {ϒ}_{+} + {ϒ}_{-} ) ( {b}_{-} {η}_{0}^{2} - {b}_{+} ) - i {η}_{0} ( {ϒ}_{+} {ϒ}_{-} - 1 ) ( {b}_{-} {b}_{+} - 1 )}{( {ϒ}_{+} + {ϒ}_{-} ) ( {b}_{-} {η}_{0}^{2} + {b}_{+} ) + i {η}_{0} ( {ϒ}_{+} {ϒ}_{-} + 1 ) ( {b}_{-} {b}_{+} - 1 )} \text{?}$$

$$\text{?} = \frac{- 2 {η}_{0} ( {ϒ}_{-} + {ϒ}_{+} {b}_{-} {b}_{+} )}{( {ϒ}_{+} + {ϒ}_{-} ) ( {b}_{-} {η}_{0}^{2} + {b}_{+} ) + i {η}_{0} ( {ϒ}_{+} {ϒ}_{-} + 1 ) ( {b}_{-} {b}_{+} - 1 )} \text{?}$$

$$\text{?} = \frac{- 2 {η}_{0} ( {ϒ}_{+} + {ϒ}_{-} {b}_{-} {b}_{+} )}{( {ϒ}_{+} + {ϒ}_{-} ) ( {b}_{-} {η}_{0}^{2} + {b}_{+} ) + i {η}_{0} ( {ϒ}_{+} {ϒ}_{-} + 1 ) ( {b}_{-} {b}_{+} - 1 )} \text{?}$$

$$\text{?} \text{indicates text missing or illegible when filed}$$

Where equation (50) is:

$${ϒ}_{\pm } = \frac{\sqrt{{k}_{‖}^{2} + {n}_{\pm }^{2} {ξ}^{2} / {c}^{2}}}{{n}_{\pm } \sqrt{{k}_{‖}^{2} + \frac{{ξ}^{2}}{{c}^{2}}}} , {η}_{0} = \sqrt{\frac{{μ}_{0}}{ϵ 0}} ,$$

And equations (51) and (52) are:

$${b}_{+} = \frac{{iv}_{+} - \frac{ω}{c} {β}_{EH}}{ω {ϵ}_{0} ϵ} ,$$

$${b}_{-} = \frac{{iv}_{-} - \frac{ω}{c} {β}_{HE}}{ω {μ}_{0} μ} ,$$

where ϵ(μ) is the permittivity (permeability) of the chiral medium, respectively, and v_{±}=(ω/c) n_{±}, where n_{±} is the index of refraction of the right (n₊) and left (n₋) circular-polarizations, respectively. Explicit expression for n_{±} is given by equation (53) as:

$${n}_{\pm } = \sqrt{ϵμ - \frac{{( {β}_{EH} + {β}_{HE} )}^{2}}{4}} ∓ \frac{i}{2} ( {β}_{EH} - {β}_{HE} ) .$$

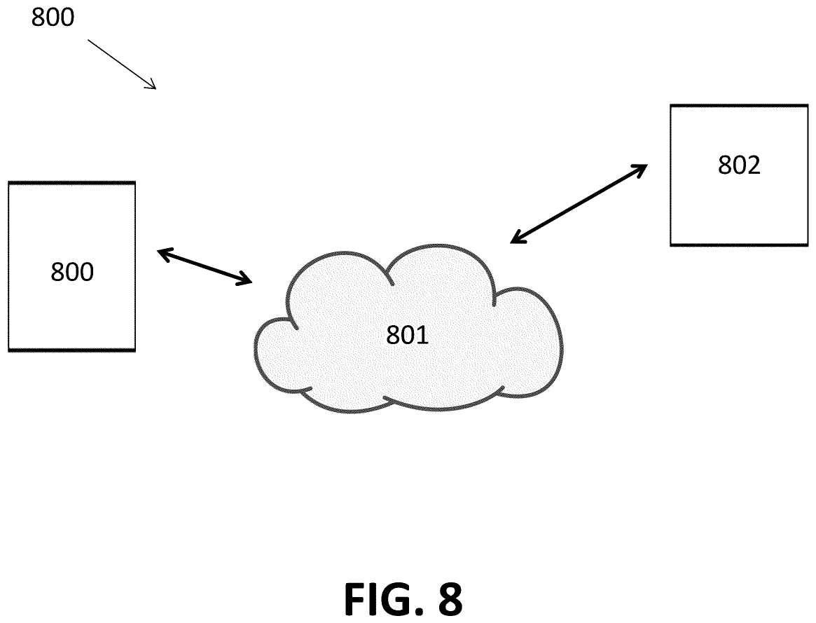

FIG. 8 is a diagram of example environment 800 in which systems, devices, and/or methods described herein may be implemented. FIG. 8 shows network 801, apparatus 800, and database 802. Network 801 may include a local area network (LAN), wide area network (WAN), a metropolitan network (MAN), a telephone network (e.g., the Public Switched Telephone Network (PSTN)), a Wireless Local Area Networking (WLAN), a WiFi, a hotspot, a Light fidelity (LiFi), a Worldwide Interoperability for Microware Access (WiMax), an ad hoc network, an intranet, the Internet, a satellite network, a GPS network, a fiber optic-based network, and/or combination of these or other types of networks.

Additionally, or alternatively, network 801 may include a cellular network, a public land mobile network (PLMN), a second generation (2G) network, a third generation (3G) network, a fourth generation (4G) network, a fifth generation (5G) network, and/or another network. In embodiments, network 822 may allow for devices describe in any of the figures to electronically communicate (e.g., using emails, electronic signals, URL links, web links, electronic bits, fiber optic signals, wireless signals, wired signals, etc.) with each other so as to send and receive various types of electronic communications. In embodiments, network 801 may include a cloud network system that incorporates one or more cloud computing systems.

Apparatus 800 may include any computation or communications device that is capable of communicating with a network (e.g., network 801). Apparatus 800 is described in FIG. 8 and may include additional features described herein. For example, apparatus 800 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a desktop computer, a laptop computer, a tablet computer, a camera, a personal gaming system, a television, a set top box, a digital video recorder (DVR), a digital audio recorder (DUR), a digital watch, a digital glass, or another type of computation or communications device.

Apparatus 800 may receive and/or display electronic content. In embodiments, the electronic content may include objects, data, images, audio, video, text, files, and/or links to files accessible via one or more networks. Content may include a media stream, which may refer to a stream of electronic content that includes video content (e.g., a video stream), audio content (e.g., an audio stream), and/or textual content (e.g., a textual stream). In embodiments, an electronic application may use an electronic graphical user interface to display content and/or information via apparatus 100. Apparatus 800 may have a touch screen and/or a keyboard that allows a user to electronically interact with an electronic application or a webpage (either containing electronic content). In embodiments, apparatus 800 may be used to generate one or more graphs and analysis as described in FIGS. 1-7.

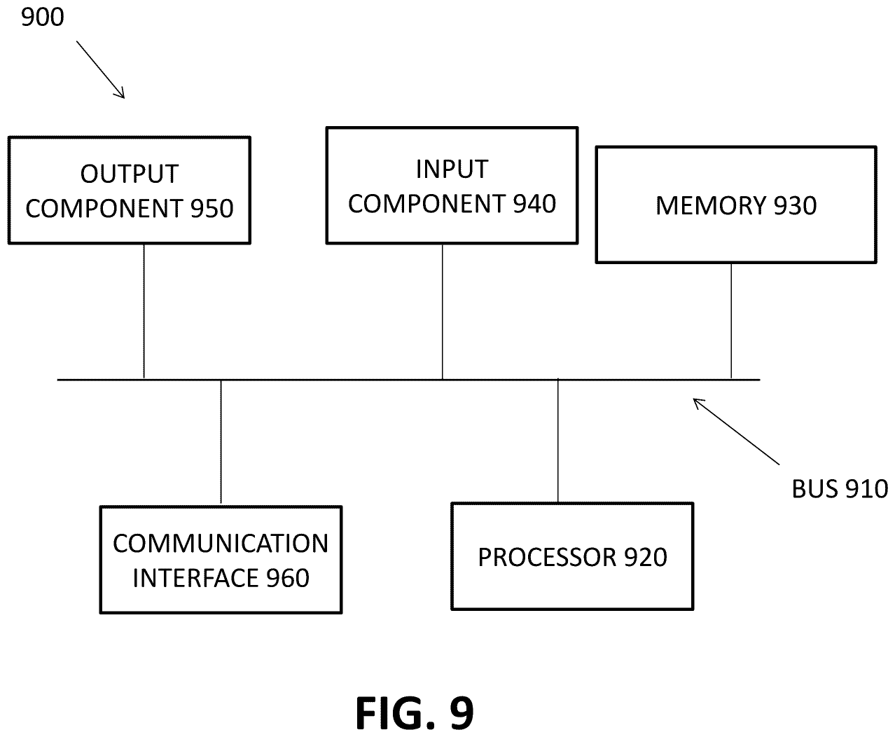

FIG. 9 is a diagram of example components of a device 900. Device 900 may correspond to network 801, apparatus 800, and computing system 814. Alternatively, or additionally, network 801, apparatus 800, computing system 814, and/or database 802 may include one or more devices 900 and/or one or more components of device 900.

As shown in FIG. 9, device 900 may include a bus 910, a processor 920, a memory 930, an input component 340, an output component 950, and a communications interface 360. In other implementations, device 900 may contain fewer components, additional components, different components, or differently arranged components than depicted in FIG. 9. Additionally, or alternatively, one or more components of device 900 may perform one or more tasks described as being performed by one or more other components of device 900.

Bus 910 may include a path that permits communications among the components of device 900. Processor 920 may include one or more processors, microprocessors, or processing logic (e.g., a field programmable gate array (FPGA) or an application specific integrated circuit (ASIC)) that interprets and executes instructions. Memory 930 may include any type of dynamic storage device that stores information and instructions, for execution by processor 920, and/or any type of non-volatile storage device that stores information for use by processor 920. Input component 940 may include a mechanism that permits a user to input information to device 800, such as a keyboard, a keypad, a button, a switch, voice command, etc. Output component 950 may include a mechanism that outputs information to the user, such as a display, a speaker, one or more light emitting diodes (LEDs), etc.

Communications interface 960 may include any transceiver-like mechanism that enables device 900 to communicate with other devices and/or systems. For example, communications interface 960 may include an Ethernet interface, an optical interface, a coaxial interface, a wireless interface, or the like. In another implementation, communications interface 960 may include, for example, a transmitter that may convert baseband signals from processor 920 to radio frequency (RF) signals and/or a receiver that may convert RF signals to baseband signals. Alternatively, communications interface 960 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 960 may connect to an antenna assembly (not shown in FIG. 9) for transmission and/or reception of the RF signals. The antenna assembly may include one or more antennas to transmit and/or receive RF signals over the air. The antenna assembly may, for example, receive RF signals from communications interface 960 and transmit the RF signals over the air, and receive RF signals over the air and provide the RF signals to communications interface 960. In one implementation, for example, communications interface 960 may communicate with network 201.

As will be described in detail below, device 900 may perform certain operations. Device 900 may perform these operations in response to processor 920 executing software instructions (e.g., computer program(s)) contained in a computer-readable medium, such as memory 330, a secondary storage device (e.g., hard disk.), or other forms of RAM or ROM. A computer-readable medium may be defined as a non-transitory memory device. A memory device may include space within a single physical memory device or spread across multiple physical memory devices. The software instructions may be read into memory 930 from another computer-readable medium or from another device. The software instructions contained in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

The above-described examples may be implemented in many different forms of software, firmware, and hardware in the implementations illustrated in the figures. In embodiments, the actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing and/or electronic networking environment and may require one or more computing devices, as described in FIG. 2, to complete such actions. Also, it will be understood that any of the various actions can result in any type of electronic information to be displayed in real-time and/or simultaneously on multiple devices. For FIG. 4, the order of the blocks may be modified in other implementations. Further, non-dependent blocks may be performed in parallel.

In the preceding specification, food may be any type of food, liquid, mixture of food and liquid, and/or any item that is edible by a person or animal. In the preceding specification, the term gas may describe a single gas or a mixture of gas.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An apparatus, comprising:
two identical finite slabs,
wherein:
the two identical finite slabs are constructed of cesium vapor atoms, and wherein the two identical finite slabs are under an effect of electromagnetically induced chirality,
the electromagnetically induced chirality effect is based on the interference between an electric and a magnetic field,
a Casimir force is computed based on the effect of a spontaneously generated coherence (SGC) and the relative phase between the electromagnetic fields, and
the SGC fully controls the Casimir force.

2. The apparatus of claim 1, wherein a Casimir interaction energy per unit area (CIEPA) and force (CFPA), based on the Casimir force, are determined using a Casimir-Lifshitz formula.

3. The apparatus of claim 2, wherein the CIEPA and CFPA are controlled and manipulated by the SGC.

4. The apparatus of claim 3, wherein the CFPA is switched from attractive to repulsive and vice versa based on a variation of a strength of SGC.

5. The apparatus of claim 1, wherein apparatus includes two doubly-degenerate ground states|1 [symbol] =|[6S_{1/2}, F=3] [symbol] and |2 [symbol] =|[6S_{1/2}, F=4] [symbol] and two excited states|3>=|[6P_{3/2}, F=2] [symbol] and |4 [symbol] =|[6F_{3/2}, F=4] [symbol] .
